(19) United States
(12) Patent Application Publication
(10) Pub. No.: US 2009/0169050 A1
(43) Pub. Date: Jul. 2, 2009

(54) METHOD FOR CHARACTERIZATION OF OBJECTS

(75) Inventors: Franz-Erich Wolter, Berlin (DE); Martin Reuter, Hannover (DE); Niklas Peinecke, Hannover (DE)

Correspondence Address: WHITHAM, CURTIS & CHRISTOFFERSON & COOK, P.C., 11491 SUNSET HILLS ROAD, SUITE 340, RESTON, VA, 20190, US

(73) Assignee: UNIVERSITÄT HANNOVER, Hannover (DE)

(21) Appl. No.: 11/916,104

(22) PCT Filed: May 18, 2006
(86) PCT No.: PCT/DE06/00857

§ 371 Date: Dec. 8, 2008

(30) Foreign Application Priority Data
Jun. 1, 2005 (DE) 10 2005 025 578.7

(51) Int. Cl. G06K 9/00

(52) U.S. Cl. 382/100

(57) ABSTRACT

A method for characterization of objects has the steps of:
a) describing an object with an elliptical self-adjoint eigenvalue problem in order to form an isometrically invariant model;
b) determining eigenvalues of the eigenvalue problem; and
c) characterizing the object by the eigenvalues.

There is a great need to clearly characterize complex technical objects in order to be able to quickly and easily detect deviations in shape in the production process, for example, or to be able to find representations of technical objects, in particular CAD drawings, in a database again.

The interchange of information is becoming increasingly important in the modern information age. Commodities are no longer produced only by manufacturing physical objects but rather using the manufacturing information. A significant part of the effort needed to manufacture a physical object already resides in creating a descriptive three-dimensional model of the object.

Surfaces and bodies are conventionally described in digital form with the aid of CAD (Computer-Aided Design) systems. A wide variety of objects are represented in this case with the aid of NURBS (Non-Uniform Rational B-Splines) surfaces. Meanwhile, an important part of the production process is the creation of a digital data model that describes the shape. The creation of such a digital model is often a very cost-intensive process. The operation of creating the physical object from the digital data is increasingly being automated. It is therefore very important to have the digital models available in complex databases and to be able to safeguard claims of ownership of these digital models.

Since digital data models are generally accessed in many ways, for example for presentations for possible buyers or in the design process by different designers, it is usually easily possible to acquire an unauthorized copy of the data. The increasingly widespread communication via the Internet increases the likelihood of data models being spied out. Added to this is the possibility of selecting an entirely different representation of the data model or reconstructing a data model from a physical object even with the aid of laser scans or other measurements, with the result that an unauthorized copy can usually scarcely be proved.

It is therefore a conventional method to impress a so-called “digital watermark” on the digital model. The legitimate owner of a model can thus be subsequently identified in an improved manner. However, it is absolutely necessary in this case to ensure that the watermark cannot be destroyed by data conversions or by intentional manipulation. In the case of digital watermarks, a distinction is made, in principle, between visible watermarks which can be identified in the model by a person and invisible watermarks which can be extracted from the data model with the aid of a computer program.

Digital watermarks are used, in particular, for image data, video data and audio data. However, many of these techniques are readily vulnerable in the case of three-dimensional models of objects since concealed data which are impressed by means of slight shifts of the control points or by adding patterns to the grid can often be easily destroyed, for example, with the aid of coordinate transformations, random noise or other actions. Added to this is the fact that these methods cannot be directly applied to CAD-based data models which are usually present in the NURBS or B-spline representation. Copy protection is desirable, in particular, with this type of data model since these data models afford the richest variety of shapes in the case of free-form objects bounded by surfaces.

R. Ohbuchi, H. Masuda, M. Aono: “Watermarking Three-Dimensional Polygonal Models Through Geometric and Topological Modifications”, in: IEEE Journal on Selected Areas in Communications, 16 (1998), no. 14, pages 551 to 560 describes a method for incorporating digital watermarks into three-dimensional polygon models, in which the corner points and the topology of the 3D model are changed. Information is embedded in the triangles used to describe a 3D model by appropriately adapting the ratios of the edges or the angles. A second method uses the ratios of the tetrahedron volume, which are invariant in affine transformations, to store information. In this case, corner points are again shifted slightly in order to adapt the volumetric ratios. Methods which change the topological structure of triangulation by introducing visible changes, for example, by subdividing some triangles are also proposed.

Yeo, B.; Yeung, M.: “Watermarking 3D Objects for Verification”, in: IEEE Computer Graphics and Applications 19 (1999), no. 1, pages 36 to 45 describes a method for embedding watermarks in 3D models, in which corner points of triangles are shifted in such a manner that certain hash functions of the corner points correspond to hash functions of the centers of the adjoining triangles. An unauthorized change to an original can be determined by virtue of the fact that this information is destroyed.

Benedens, O.: “Geometry-Based Watermarking of 3D Models”, in: IEEE Computer Graphics and Applications 19 (1999), no. 1, pages 46 to 55 discloses a method for embedding watermarks in the surface normals of an object model. This method which changes group-like normals in order to store information is resistant, in the case of a dense initial breakdown, to the breakdown changes and, for example, to polygon simplifications.

Kanai, S.; Date, H.; Kishinami, T.: “Digital Watermarking for 3D Polygons using Multiresolution Wavelet Decomposition”, in: Proceedings of the Sixth IFIP WG 5.2/GI International Workshop on Geometric Modeling: Fundamentals and Applications, 1998, pages 296 to 307 discloses a method for incorporating watermarks in the frequency domain of a 3D model. For this purpose, use is made of wavelet transformations and multiscalar representations to accommodate the information in the wavelet coefficient vector at one stage of resolution or different stages of resolution. The robustness of the method, which is resistant to affine transformations and polygon simplifications, can be controlled on the basis of the stage.

Fornaro, C.; Sanna, A.: “Public Key Watermarking for Authentication of CSG Models”, in: Computer Aided Design 32 (2000), no. 12, pages 727 to 735 describes an encryption method based on public keys for authenticating models for describing objects with the solid body geometry. In order to store information in the solids, new nodes are inserted into the so-called CSG tree of the model. As a result of zero-volume objects, for example a sphere with a radius of zero, the watermarks remain invisible. However, this technique is susceptible to malicious changes by the user.

Ohbuchi, R.; Mukaiyama, A.; Takahashi, S.: A Frequency-Domain Approach to Watermarking 3D Shapes, in: Computer Graphics Forum, ISSN 0167-7055, Proc. EUROGRAPHICS 2002, edited by G. Dettrakis and H.-P. Seidel, Malden: Blackwell Publishing, 2002, vol. 21, pages 373-382 describes a method for characterizing objects, which is used to add watermarks in the frequency domain. In order to recognize objects, data are thus actively affixed to the objects. The method relates to polygonal meshes. Transformation to the frequency domain is carried out using a discrete matrix which includes solely the connectivity of the polygonal mesh. For this purpose, eigenvalues and vectors of the Kirchhoff matrix are calculated.

Ohbuchi, R.; Masuda, H.; Aono, M.: “A Shape-Preserving Data Embedding Algorithm for NURBS Curves and Surfaces”, in: Proceedings of the International Conference on Computer Graphics, IEEE Computer Society, 1999, Canmor, Canada, June 4 to June 11, pages 180 to 187 discloses the practice of adding watermarks with the aid of rational linear parameterizations for non-uniform rational B-spline (NURBS) curves and surfaces. This method is easy to apply and retains the exact shape of the NURBS object since redundant reparameterization is used. However, the watermark information can be removed easily without reducing the quality of the surface by reapproximating the object, for example.

Embedding watermarks according to the abovementioned methods makes it possible to protect polygonal 3D models which are described, for example, using the Virtual Reality Modeling Language (VRML). Since, in CAD designs, the models are usually in the form of free-form curves and surfaces, for example B-splines or NURBS, the methods, apart from the last-mentioned method, are not suitable for protecting CAD data. Since the use of special CAD systems and the collaboration of technical designers via the Internet have become very widespread in the meantime in the field of design, there is an urgent need to protect CAD data.

US-2003-0128209 describes a method in which the shapes of the objects are compared. For this purpose, the objects to be compared are first of all made to coincide with the aid of volumes and moments of inertia. The objects are then compared using a weak, a medium and a strong test. The weak and medium tests are carried out on nodes and the strong test is based on comparing isolated umbilical points. It is finally possible, on the basis of these tests, to provide a statement regarding whether one of the objects is a possibly illegal copy of the original. The disadvantage is that the objects must first of all be made to coincide with one another in a complicated manner in order to carry out the comparison.

Therefore, it is an object of the invention to provide an improved method for characterization of objects, which can be used, in particular, to protect technical CAD drawings and find designed technical objects in a complex CAD drawing database.

The object is achieved, with the method of the generic type, by means of the steps of:
a) describing an object with an elliptical self-adjoint eigenvalue problem in order to form an isometrically invariant model;
b) determining eigenvalues; and
c) characterizing the object by the eigenvalues.

Characterizing the object using the eigenvalues of an elliptical self-adjoint eigenvalue problem, if appropriate with boundary conditions, makes it possible to compare objects by comparing the eigenvalue sequence of an object without the position of the object in the space, in particular a rotation, influencing the comparison. The method is independent of the representation of the objects, in particular the parameterization. It is thus possible to use different models, for example NURBS, triangulated surfaces, height functions, to directly compare described objects with one another without model transformation. So that the eigenvalue problem is isometrically invariant, the operator depends only on the metrics, that is to say the distance between two respective points on the surface. This has the advantage that surface deformations do not impair the comparison if the geodesic distance between two respective arbitrary points is not changed in the case of the surface deformations.

The calculation of elliptical self-adjoint eigenvalue problems in objects using the finite elements method, for example, is sufficiently well known per se. The theoretical principles of such elliptical differential equations are described in Bronstein, Semendjajew: “Taschenbuch der Mathematik” [Mathematics pocketbook], BSB Teubner, 1987, page 478. In addition, the eigenvalues are now used as characteristic values for describing the object.

In contrast to methods in which watermarks are affixed to objects, it is proposed to analyze the respective object by taking the eigenvalues of the Laplace-Beltrami operator as a fingerprint and using them to calculate differences. For this purpose, a differential equation system which is independent of the representation and is only dependent on the shape is solved. The method is not restricted to polygonal meshes but is generally valid. It may also be used, for example, for parameterized surfaces or for bodies.

It is particularly advantageous if the differential equation system has a Laplace-Beltrami operator. It has been found that this Laplace-Beltrami operator enables characterization which is particularly useful for the abovementioned purposes. In particular, the effect of uniform scaling on the eigenvalues can be reversed again.

The differential equation system may be, for example, a Helmholtz differential equation according to the formula

Δf=−λf

with the operator A, the eigenfunctions f and the eigenvalues λ. Such a Helmholtz differential equation has the advantage that it results, in a manner known per se, in the formation of an isometrically invariant model of a technical object.

The characterization of the objects is preferably standardized to a basic scaling by dividing the eigenvalues by the first value that is not equal to zero in the sequence of eigenvalues which has been sorted according to the magnitude of the eigenvalues.

However, the characterization of the objects can also be standardized to a basic scaling by means of the steps of:
a) determining an equalizing function f(n)=c n/^{d/2} using a fixed number N of eigenvalues, starting from the beginning of the sequence, with the scaling factor c, the position n of the eigenvalue in the sequence and the dimension d of the object; and
b) scaling the eigenvalues with a scaling factor selected in such a manner that the equalizing function is mapped to a fixed standard function, for example by dividing the eigenvalues by the scaling factor c.

When characterizing the objects with a sequence of eigenvalues according to the described method, an increase/reduction in the size of the object results in a change in all of the eigenvalues in a sequence by the same scaling factor. That is to say standardization using the steps a) to c) makes it possible to directly compare the eigenvalue sequence for two objects independently of their size.

However, the characterization of the objects can also be standardized to a unit area or a unit volume by multiplying the eigenvalues by the value of the area (A) or the volume raised to the power 2/3 (V^{2/3}).

It is particularly advantageous if the characterization of the objects is scaled by multiplying the eigenvalues by a scaling factor s², where s is the scaling factor for the object. With a known scaling factor, use is thus made of the fact that all eigenvalues in the sequence of eigenvalues used to characterize an object are adapted by the same scaling factor.

In the case of volume bodies, it is advantageous to calculate the spectrum of the body and the spectrum of the body shell (of the two-dimensional edge) and to use them for the eigenvalue problem. Even more accurate characterization is thus possible.

The characterization of the objects can be used to compare the similarity in shape of objects by determining the similarity of the eigenvalue sequences or scaled eigenvalue sequences for the objects to be compared. This comparison can be used, for example, to find representations of objects in databases, that is to say, for example, to use the eigenvalue sequences to look through databases containing CAD drawings. Furthermore, the comparison of the similarity in shape can be used to protect copyrights on object representations. Furthermore, the comparison of the similarity in shape can be used in the production of goods to detect deviations in shape by automatically detecting the shape of the objects produced (for example by means of camera recordings or laser scans), by transforming the objects into a 2D/3D model and by determining the eigenvalue sequences for this model.

The similarity in shape may be effected, for example, by determining the Euclidean distance d(λ, μ)ₙ of the eigenvalue sequences for two objects in accordance with the formula

$${d ( λ , μ )}_{n} = {‖ ( {λ}_{1} , … , {λ}_{n} ) - ( {μ}_{1} , … , {μ}_{n} ) ‖}_{2} = \sqrt{{\sum }_{i = 1}^{n} {( {λ}_{1} - {μ}_{1} )}^{2}}$$

where λᵢ is the possibly standardized eigenvalues for a first object, μᵢ is the eigenvalues for a second object and n is the number of eigenvalues in a respective sequence.

However, it is also possible to use other suitable metrics for comparing the possibly standardized eigenvalue sequences. In this case, it is advantageous to determine the correlation between the eigenvalues in the sequence for a first object and the eigenvalues in the sequence for a second object. This method has the advantage that the correlation is independent of the scaling.

It is also advantageous to calculate the so-called Hausdorff distance, in which every value of the eigenvalues in one sequence is compared with every other eigenvalue in the sequence for the comparison object. Therefore, the position of the eigenvalues does not play a role.

Geometric data for the object, for example the area of the surface, the volume of the body, the length of the edge and/or the area of the edge surface of the object, can advantageously be extracted from the sequence of eigenvalues for an object. It is also possible to determine the number of holes in a planar surface with a smooth edge or the genus of a closed surface by determining the Euler characteristic from the sequence of eigenvalues.

In order to characterize gray scale value images, it is advantageous to convert them into height functions by allocating each point in the image a height which corresponds to its gray scale value. A two-dimensional surface which is embedded in the three-dimensional space and for which the eigenvalues can be determined according to the above-described method thus results. For color images, a generalized height function which allocates three height values to each pixel on the basis of the respective color components (for example red, blue, green or luminance, chrominance-red, chrominance-blue) can be created in an analogous manner. A two-dimensional surface which is embedded in the five-dimensional space and for which the eigenvalues can be determined thus results. Alternatively, each color channel can also be interpreted as an independent height function, with the result that three separate spectra need to be characterized.

For reasons of performance, the method can preferably be implemented in the form of hardware or in the form of a computer program with program code means which carry out the above-described method if the computer program is executed on a computer.

The invention is explained by way of example in more detail below using the accompanying drawings, in which:

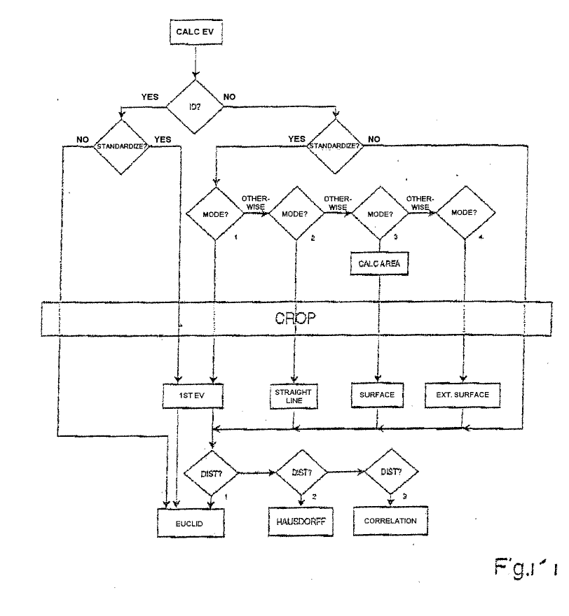

FIG. 1 shows a flowchart of a method for characterizing objects, extracting geometric data and comparing the similarity in shape of objects;

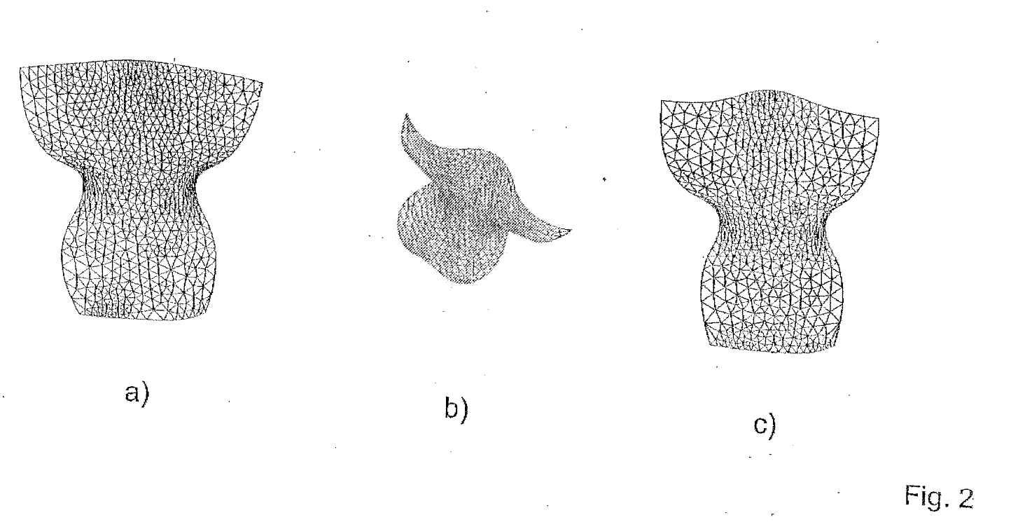

FIGS. 2a to c show a B-spline representation of two views of the back of a mannequin A and of the back of a second mannequin B.

FIG. 1 reveals a flowchart of the method for characterizing objects.

In a first step CALC EV, a sequence of eigenvalues of an elliptical self-adjoint differential equation system, which is used to describe the object, is calculated. For this purpose, the Helmholtz differential equation

Δf=−λf

is solved, for example. This is also known as a Laplace eigenvalue problem. In this case, Δ is the Laplace-Beltrami operator. The countably numerous solutions f of the Helmholtz differential equation are called eigenfunctions and λ eigenvalues. These eigenvalues λ are positive and form the so-called spectrum of the object. It is possible to calculate the Helmholtz differential equation for 2D surfaces (planar or curved surfaces in the space) or else for 3D bodies. The representation of the object does not play a role in this case since the numerical calculation of the Helmholtz differential equation can, in principle, be carried out for a wide variety of forms of representation with the same results for the eigenvalues, for example for parameterized surfaces (for example NURBS), faceted surfaces and bodies, implicitly given surfaces, height functions (for example derived from images) etc.

The sequence of eigenvalues λ (spectrum) is calculated with the aid of numerical methods for solving the Helmholtz differential equation. This can be carried out, for example, with the aid of the finite elements method which, on account of its flexibility, can be used both for surfaces and for bodies. Alternative methods for calculating the eigenvalues λ in a more rapid or more accurate manner are available in special cases (for example in the case of planar polygons) in which certain knowledge of the solutions of the Helmholtz differential equation is used.

In the step CALC EV, the eigenvalues λ are calculated as accurately as possible in order to avoid computation inaccuracies which interfere with subsequent comparison of the eigenvalue sequences (fingerprints) for objects. A large number of eigenvalues λ are additionally required for the possible extraction of geometric data.

The spectrum of an object is thus characterized by the eigenvalues λ which are sorted according to magnitude in the form of a sequence of positive numbers. In this case, the first eigenvalue λ is exactly zero when the object is not bounded. Since the spectrum is an isometric invariant, that is to say does not change in isometric transformations, the spectrum is independent of the position (translation and rotation) and the representation of the object (in particular parameterization independence).

In a subsequent step “ID?”, a decision is made as to whether the similarity of at least two objects or only the identity of one object is intended to be checked. In both cases, it is then determined whether the eigenvalue sequences are intended to be standardized. This is carried out in the step “standardize?”.

Standardization can be carried out, for example, in accordance with the following methods:
a) The eigenvalue sequences are standardized according to the first eigenvalue in the sequence. For this purpose, each eigenvalue λ in the sequence is divided by the first eigenvalue λ in the sequence which is greater than zero.
b) In the standardization method “straight line”, an equalizing straight line is calculated using the first N eigenvalues λ. The sequence of eigenvalues λ is then scaled in such a manner that the gradient of the equalizing straight line corresponds to a defined value, for example one. However, an equalizing function can also generally be scaled in such a manner that it is mapped to a standard function. This is necessary, for example, in the case of larger dimensions.
c) In a third method, the area A is first of all calculated from the eigenvalues λ (“CALC AREA”). In the step “surface”, the eigenvalues λ in a sequence are then multiplied by the area A. However, it is also optionally possible to determine the volume V in the case of bodies and to multiply the eigenvalues λ by V^{2/3}.
d) In an optional method “EXT surface”, the eigenvalues λ can also be standardized with regard to the actual area A or volume V^{2/3} of the object.

Standardizing the eigenvalues λ according to method a) makes it possible to ignore scaling. Slight deformation of an object additionally results in very similar eigenvalues λ since the eigenvalues λ always depend on the shape of the surface of the body. Slightly deformed objects can also be identified.

For the case of similarity investigations, the first standardization method a) or the three further standardization methods b), c) or d) can be selected for “mode?”_{1, 2, 3, 4}.

Standardization of the eigenvalues λ with V^{2/3} is substantiated by the Weyl asymptotic law of distribution, according to which the eigenvalues λₙ of a d-dimensional object behave like c(d)*n^{2/d}/V^{2/d}, where c(d) is a dimension-dependent constant, n is the number of the eigenvalue λ in an eigenvalue sequence organized according to the magnitude of the eigenvalues λ, and V is the d-dimensional volume of the object. In the case d=2, V is the area, for example. In order to change the spectra to a form that is independent of the volume and thus independent of the scaling, it is thus necessary to multiply the eigenvalues by the factor V^{2/d}. That is simply the area for two-dimensional objects and the volume V^{2/3} for three-dimensional bodies.

Before standardization, the sequence of eigenvalues can be shortened to approximately 10 to 100 eigenvalues λ, which generally suffice for standardization and the similarity calculation, in a step “CROP”, preferably after the area calculation “CALC AREA”.

It is known that asymptotic development of the so-called “Heat Trace Z(t)” (the trace of the heat kernel) exists, Z(t) depending only on eigenvalues λ and a time parameter t. The first coefficients of this asymptotic development are defined by the volume of the body (or area), the edge area (or edge length) and, in some cases, by the Euler characteristic of the object. In order to numerically calculate this variable, the heat trace Z(t) can be converted into a new function X(x) by substituting x:=\sqrt{(t)} and multiplying by x^{d}, with the result that, with a sufficiently large number of eigenvalues, it is possible to calculate some support points of X and thus to extrapolate for t->0. This makes it possible to extract the geometric variables from a spectrum with a limited number of eigenvalues and to use them for standardization or classification. The first approximately 500 eigenvalues in the eigenvalue sequence which has been sorted according to magnitude are usually sufficient for this purpose.

It is necessary to standardize or scale the eigenvalues λ only when comparison objects are not stored on an absolute scale and the size of the object shall not be taken into account in a comparison. This case occurs, for example, when an avoidably stolen data record is intended to be compared with the original. It may then be entirely the case that the two objects differ greatly in terms of their size but are identical again in terms of their shape after scaling.

In a subsequent step “DIST?”, the identity of shape of two objects is compared. For this purpose, the eigenvalues λ in a first sequence for a first object are compared with the eigenvalues μ in a second sequence for a second object. A comparison that is independent of the size of the objects is possible as a result of the previous scaling of the eigenvalues λ, μ.

The similarity in shape can be compared, for example, by determining the Euclidean distance of two sequences of eigenvalues λ=(λ₁, λ₂, . . . , λₙ) and μ=(μ₁, μ₂, . . . , μₙ) (“EUCLID”). The Euclidean distance d(λ, μ)ₙ is calculated in accordance with the formula:

$${d ( λ , μ )}_{n} = {‖ ( {λ}_{1} , … , {λ}_{n} ) - ( {μ}_{1} , … , {μ}_{n} ) ‖}_{2} = \sqrt{{\sum }_{i = 1}^{n} {( {λ}_{1} - {μ}_{1} )}^{2}}$$

The more similar the shape of the two compared objects, the smaller the Euclidean distance d(λ, μ)ₙ.

However, it is also possible to calculate the so-called Hausdorff distance. For this purpose, each eigenvalue λ in the first sequence for the first object is compared with each eigenvalue μ in the second sequence for the second object. In this case, the position of the eigenvalues λ, μ, in particular, does not play a role. This method is sketched as “Hausdorff” in FIG. 1.

Another possibility is to calculate the correlation between two eigenvalue sequences (“correlation”). There is then no need to extract geometric data and scale the eigenvalues since the correlation is independent of the scaling. However, the correlation may be relatively high under certain circumstances in the case of very different objects, with the result that correlation values may be very close together even though there is no similarity in shape. Therefore, the method is not always clear.

FIGS. 2a) and 2b) reveal a model representation of the back of a first mannequin A in two different perspective views A) and B). The object A is modeled in the form of a B-spline patch. Although the representation in FIG. 2b) looks completely different to the two other representations, it shows the identical mannequin A after rotating, shifting, scaling and increasing the degree of the Bezier functions.

In contrast, FIG. 2c) shows a modified back of a second mannequin B with a narrower waist and narrower shoulders. The B-spline patches A and B are very similar but not identical.

The eigenvalues λ of the Helmholtz differential equation were calculated using a Laplace-Beltrami operator for the B-spline patches of the representations from FIGS. 2a), b) and c). Furthermore, the unit values λ for a unit square Q were calculated. The first ten eigenvalues are listed in non-standardized form in the following table:

| | A | A^{′} | B | Q |
|---|---|---|---|---|
| λ₁ | 23.2129 | 64.4805 | 21.8896 | 19.7392 |
| λ₂ | 38.1205 | 105.8899 | 35.5664 | 49.348 |
| λ₃ | 66.8692 | 185.7453 | 65.1522 | 49.348 |
| λ₄ | 68.8359 | 191.2107 | 64.3064 | 78.9568 |
| λ₅ | 79.9423 | 222.0649 | 79.562 | 98.696 |
| λ₆ | 109.2467 | 303.4608 | 99.5094 | 98.696 |
| λ₇ | 112.6647 | 312.9567 | 106.6091 | 128.305 |
| λ₈ | 128.7539 | 357.649 | 122.9286 | 128.305 |
| λ₉ | 151.781 | 421.6125 | 142.8177 | 167.783 |
| λ₁₀ | 154.8085 | 430.0306 | 147.2477 | 167.783 |
| Distance | 0 | 13365.13 | 391.2229 | 792.8685 |
| 100 to A | | | | |

The distance 100 to A is the Euclidean distance of the sequence of eigenvalues λᵢ, which has been reduced to 100 values, to the sequence of eigenvalues λ for the surface A.

It can be seen that the sequences of eigenvalues of the representation from FIG. 2c) differ less from the representation from FIG. 2a) than the representation from FIG. 2b) differs from the representation from FIG. 2a) even though FIGS. 2a) and 2b) describe the identical object A. The reason for this is that the eigenvalues λ are also scaled when the object is scaled. In order to compensate for this effect, the eigenvalues λᵢ in the sequences are therefore scaled in such a manner that the respective first eigenvalue λ corresponds.

The following table lists the correspondingly standardized eigenvalues λᵢ in the sequences as well as the Euclidean distances to the B-spline patch A.

| | A | A^{′} | B | Q |
|---|---|---|---|---|
| λ₁ | 1 | 1 | 1 | 1 |
| λ₂ | 1.6422 | 1.6422 | 1.6248 | 2.5 |
| λ₃ | 2.8807 | 2.8806 | 2.8393 | 2.5 |
| λ₄ | 2.9654 | 2.9654 | 2.9378 | 4 |
| λ₅ | 3.4439 | 3.4439 | 3.6347 | 5 |
| λ₆ | 4.7063 | 4.7062 | 4.546 | 5 |
| λ₇ | 4.8535 | 4.8535 | 4.8703 | 6.5 |
| λ₈ | 5.5467 | 5.5466 | 5.6158 | 6.5 |
| λ₉ | 6.5386 | 6.5386 | 6.5245 | 8.5 |
| λ₁₀ | 6.6691 | 6.6692 | 6.7268 | 8.5 |
| Distance | 0 | 0.0031 | 4.7462 | 98.0448 |
| 100 to A | | | | |

It can be seen that there is very great similarity in shape between the B-spline patches A and A′, that is to say the Euclidean distance of the 100 smallest eigenvalues λ is only 0.0031 even though A′ has been produced from A by translation, rotation, scaling and increasing the degree and actually looks completely dissimilar to A. Furthermore, it becomes clear that, even though the object B is very similar to the object A, it has the Euclidean distance of 4.7462 and is thus not identical to the object A. In comparison with the unit square Q, which, with a distance of 98, is relatively far away from the object A, the degree of similarity can also still be objectively determined.

A further possible way of comparing eigenvalue sequences is to calculate the equalizing straight lines of the first eigenvalues λ₁, λ₂, . . . , λₙ and then to adapt the gradients of the equalizing straight lines. This is listed in the following table for the objects A, A′, B and the unit square Q, the equalizing straight lines each having the gradient 4Π.

| | A | A′ | B | Q |
|---|---|---|---|---|
| λ₁ | 23.6224 | 23.6225 | 23.4599 | 18.085 |
| λ₂ | 38.7929 | 38.7929 | 38.1178 | 45.2128 |
| λ₃ | 68.0487 | 68.048 | 66.6108 | 45.2128 |
| λ₄ | 70.0501 | 70.0502 | 68.9195 | 72.3405 |
| λ₅ | 81.3524 | 81.3537 | 85.2695 | 90.4256 |
| λ₆ | 111.174 | 111.1731 | 106.6479 | 90.4256 |
| λ₇ | 114.652 | 114.652 | 114.2569 | 117.5534 |
| λ₈ | 131.025 | 131.025 | 131.7471 | 117.5534 |
| λ₉ | 154.458 | 154.4581 | 153.063 | 153.7233 |
| λ₁₀ | 157.539 | 157.542 | 157.8108 | 153.7233 |
| Distance | 0 | 0.0681 | 98.3908 | 182.9741 |
| 100 to A | | | | |

It can be seen that the identity of the objects A and A′, with a distance of 0.0681, is no longer as clear as with the standardization of the unit values according to table 2. However, the method is highly suitable for detecting similarities.

The method for characterization of objects makes it possible to identify and compare surfaces and bodies with the aid of eigenvalue sequences in order to find objects in large quantities of data or to obtain a copy protection method for parameterized surfaces and bodies, for example. A comparison is possible in this case without the need for the objects to spatially coincide (translation, rotation, scaling) and without the need for a common representation of the data.

1. A method for characterization of objects, said method having the steps of:
a) describing an object with an elliptical self-adjoint eigenvalue problem in order to form an isometrically invariant model;
b) determining elgenvalues (λ) of the eigenvalue problem; and
c) characterizing the object by the eigenvalues (λ).

2. The method as claimed in claim 1, characterized in that the eigenvalue problem has a Laplace-Beltrami operator (Δ).

3. The method as claimed in claim 1, characterized in that the eigenvalue problem is a Helmholtz differential equation according to the formula:
Δf=−λf
with the operator Δ, the eigenfunctions f and the eigenvalues λ.

4. The method as claimed in claim 1, characterized by standardizing the characterization of the objects to a basic scaling by dividing the eigenvalues (λ) by the first value that is not equal to zero in the sequence of eigenvalues (λ) which has been sorted according to the magnitude of the eigenvalues (λ).

5. The method as claimed in claim 1,
characterized by standardizing the characterization of the objects to a basic scaling by
a) determining an equalizing function f(n)=c n^{d/2} using a fixed number N of eigenvalues (λ), starting from the beginning of the sequence, with the scaling factor C, the position n of an eigenvalue in the sequence and the dimension d of the object; and
b) scaling the eigenvalues (λ) with a scaling factor selected in such a manner that the equalizing function f(n) is mapped to a fixed standard function.

6. The method as claimed in claim 1, characterized by standardizing the characterization of the objects to a unit area or a unit volume by multiplying the eigenvalues (λ) by the value of the area (λ) or the volume (V^{2/3})

7. The method as claimed in claim 1, characterized by scaling the characterization of the objects by multiplying the eigenvalues (λ) by a scaling factor s², where s is the scaling factor for the object.

8. The method as claimed in claim 1, characterized by comparing the similarity in shape of objects by determining the similarity of the eigenvalue sequences (λ₁, . . . , λₙ) or scaled eigenvalue sequences (λ₁, . . . , λₙ) of the objects to be compared.

9. The method as claimed in claim 8, characterized by determining the Euclidean distance d(λ, μ)ₙ of the eigenvalue sequences (λ₁, . . . , λₙ; μ₁ . . . , μₙ) or scaled eigenvalue sequences (λ₁, . . . , λₙ; μ₁ . . . , μₙ)for two objects in accordance with the formula:
$${d ( λ , μ )}_{n} = {‖ ( {λ}_{1} , … , {λ}_{2} ) - ( {μ}_{1} , … , {μ}_{n} ) ‖}_{2} = \sqrt{{\sum }_{i = 1}^{n} {( {λ}_{1} - {μ}_{1} )}^{2}}$$
where λᵢ is the eigenvalues for a first object, μᵢ is the eigenvalues for a second object and n is the number of eigenvalues in a respective sequence.

10. The method as claimed in claim 8, characterized by determining the Hausdorff distance by respectively comparing the eigenvalues (λ) or scaled eigenvalues (λ) in the sequence for a first object (μ) with each eigenvalue (p) in the sequence for a second object.

11. The method as claimed in claim 8, characterized by determining the correlation between the eigenvalues (λ) in the sequence for a first object arid the eigenvalues (μ) in the sequence for a second object.

12. The method as claimed in claim 1, characterized by determining a height function from the gray scale values of a stored image or a generalized height function from the color values of a stored image and characterizing the image using the eigenvalues (λ) of the eigenvalue problem for the height function.

13. The method as claimed in claim 1, characterized by calculating both eigenvalues of a body and the eigenvalues of the body shell.

14. The method as claimed in claim 1, characterized by searching for representations of objects, which are stored in at least one database, by comparing the eigenvalue sequences (λ₁, . . . , λₙ) or scaled eigenvalue sequences (λ₁, . . . , λₙ) of the stored representations with an eigenvalue sequence (μᵢ . . . , μₙ ) of a sought object.

15. The method as claimed in claim 8 for identifying digital representations of objects, protecting against pirate copies and/or for quality control.

16. The method as claimed in claim 8, characterized by extracting geometric data for the object, for example the area of the surface, the volume of the body, the length of the edge or the area of the edge surface of the object, from the sequence of eigenvalues (λ).

17. The method as claimed in claim 16, characterized by determining the Euler characteristic from the sequence of eigenvalues (λ) for the purpose of determining the number of holes in a planar surface or for determining the genus of a closed surface.

18. A computer program having program code means for carrying out the method method for characterization of objects, said method having the steps of:
a) describing an object with an elliptical self-adjoint eigenvalue problem in order to form an isometrically invariant model;
b) determining elgenvalues (λ) of the eigenvalue problem; and c) characterizing the object by the elgenvalues (λ) if the program runs on a computer.

19. A circuit arrangement having computation means which are designed to carry out the method for characterization of objects, said method having the steps of:
a) describing an object with an elliptical self-adjoint eigenvalue problem in order to form an isometrically invariant model;
b) determining elgenvalues (λ) of the eigenvalue problem; and
c) characterizing the object by the eigenvalues (λ).
